(19) United States
(12) Patent Application Publication
(10) Pub. No.: US 2022/0231302 A1
(43) Pub. Date: Jul. 21, 2022

(54) ELECTRODE AND ELECTRICITY STORAGE DEVICE

(71) Applicant: HONDA MOTOR CO., LTD., Tokyo (JP)

(72) Inventors: Kiyoshi TANAAMI, Saitama (JP); Toshimitsu TANAKA, Saitama (JP); Yuji ISOGAI, Saitama (JP)

(21) Appl. No.: 17/572,512

(22) Filed: Jan. 10, 2022

(30) Foreign Application Priority Data
Jan. 21, 2021 (JP) 2021-007834

(51) Int. Cl. H01M 4/66; H01M 4/36

(52) U.S. Cl. CPC H01M 4/666; H01M 4/364

(57) ABSTRACT

Provided is an electrode including: a current collector; and an electrode material mixture, the current collector being a porous metal body, the current collector having pores filled with the electrode material mixture, the electrode material mixture including an electrode active material and porous aggregates of a conductive aid. Also provided is an electricity storage device including: the electrode; and an electrolytic solution.

This application is based on and claims the benefit of priority from Japanese Patent Application 2021-007834, filed on 21 Jan. 2021, the content of which is incorporated herein by reference.

### BACKGROUND OF THE INVENTION

### Field of the Invention

The present invention relates to an electrode and an electricity storage device.

### Related Art

In the conventional art, lithium-ion secondary batteries are in widespread use as high-energy-density, electricity-storage devices. A typical lithium-ion secondary battery includes a positive electrode, a negative electrode, a separator provided between the electrodes, and an electrolytic solution with which the separator is impregnated.

For such a lithium-ion secondary battery, a variety of needs exist depending on the intended use, such as a further increase in volume energy density for vehicle applications. Such an increase in volume energy density can be achieved by a method of increasing the packing density of an electrode active material.

A proposed method of increasing the packing density of an electrode active material includes using a foamed metal as a current collector for forming positive and negative electrodes (see Patent Documents 1 and 2). Such a foamed metal has a network structure uniform in pore size and has a large surface area. Therefore, when pores of such a foamed metal are filled with an electrode material mixture containing an electrode active material, a relatively large amount of the electrode active material can be packed per unit area of the electrode.
Patent Document 1: Japanese Unexamined Patent Application, Publication No. H07-099058
Patent Document 2: Japanese Unexamined Patent Application, Publication No. H08-329954

### SUMMARY OF THE INVENTION

Unfortunately, when a foamed metal is used as a current collector, the electrode may have a very large thickness, and the amount of the electrode active material coating may increase to twice or more that in the case where a current collector foil is used, so that the electrolytic solution may fail to smoothly infiltrate into the inside of the electrode and that insufficient supply of ions may occur. That may occur more significantly when the lithium-ion secondary battery is designed to have a high energy density. Moreover, the ions may move a relatively long distance in the electrode, which may cause the problem of an increase in ion diffusion resistance. Furthermore, during charge/discharge cycles, the electrolytic solution may move to the outside of the electrode so that the inside of the electrode may run short of the electrolytic solution, which may cause the problem of a decrease in durability.

It is an object of the present invention to provide an electrode that helps to reduce ion diffusion resistance and to improve durability.

An aspect of the present invention is directed to an electrode including: a current collector; and an electrode material mixture, the current collector being a porous metal body, the current collector having pores filled with the electrode material mixture, the electrode material mixture including an electrode active material and porous aggregates of a conductive aid.

The electrode material mixture may have a three-layer structure including an upper layer, an intermediate layer, and a lower layer stacked in order in its thickness direction, and the porous aggregates of the conductive aid may be in the intermediate layer.

Another aspect of the present invention is directed to an electricity storage device including: the electrode defined above; and an electrolytic solution.

The present invention makes it possible to provide an electrode that helps to reduce ion diffusion resistance and to improve durability.

### BRIEF DESCRIPTION OF THE DRAWINGS

FIG. 1 is a diagram showing an example of the structure of an electrode according to an embodiment of the present invention;

FIG. 2 is a photograph showing scanning electron microscope (SEM) images of a cross-section of the positive electrode of Example 1 and showing results of electron probe micro analyzer (EPMA) analysis;

FIG. 3 is a photograph showing SEM images of a cross-section of the positive electrode of Comparative Example 1 and showing EPMA analysis results;

FIG. 4 is a photograph showing SEM images of a cross-section of the positive electrode of Comparative Example 2 and showing EPMA analysis results;

FIG. 5 is a graph showing the results of evaluation of the initial cell resistances of the lithium-ion secondary batteries of Example 1 and Comparative Examples 1 and 2;

FIG. 6 is a graph showing the results of evaluation of the C-rate characteristics of the lithium-ion secondary batteries of Example 1 and Comparative Examples 1 and 2;

FIG. 7 is a graph showing the results of evaluation of the capacity retention of the lithium-ion secondary batteries of Example 1 and Comparative Examples 1 and 2; and

FIG. 8 is a graph showing the results of evaluation of the rate of change in the resistance of the lithium-ion secondary batteries of Example 1 and Comparative Examples 1 and 2.

### DETAILED DESCRIPTION OF THE INVENTION

Hereinafter, embodiments of the present invention will be described with reference to the drawings.

### Electrode

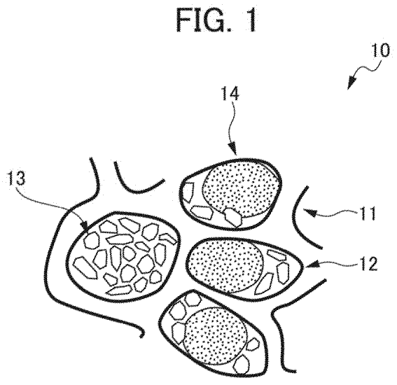

FIG. 1 shows an example of the structure of an electrode according to an embodiment of the present invention.

The electrode 10 includes a current collector 11 and an electrode material mixture 12. The current collector 11 is a porous metal body and has pores filled with an electrode material mixture 12. The electrode material mixture 12 includes an electrode active material 13 and porous aggregates 14 of a conductive aid.

The current collector 11 may have a region having pores filled with the electrode material mixture 12 and another region having pores not filled with the electrode material mixture 12.

In the electrode 10, the electrode material mixture 12 contains porous aggregates 14 of a conductive aid, into which an electrolytic solution can easily infiltrate, so that the electrode 10 can have improved ionic conductivity. This results in a significant reduction in ion diffusion resistance without a reduction in the density of the electrode 10. Moreover, the electrode material mixture 12 can have an improved ability to hold liquid, which can prevent depletion of the electrolytic solution during a cycle test and improve the durability of the electrode 10.

The electrode material mixture 12 may have a three-layer structure including an upper layer (A layer), an intermediate layer (B layer), and a lower layer (C layer) stacked in order in its thickness direction, and the B layer may contain the porous aggregates 14 of the conductive aid. In this case, the porous aggregates 14 of the conductive aid can be placed at a central portion of the electrode material mixture 12, with which pores of the current collector 11 are filled, so that an electrolytic solution will be less likely to leak outside the electrode 10.

In this case, the porous aggregates 14 of the conductive aid may be contained only in the B layer.

The porous aggregates 14 of the conductive aid may also be contained in at least one of the A and C layers. In this case, the porous aggregates 14 of the conductive aid are preferably contained more in the B layer than in the A and C layers.

### Porous Metal Body

The porous metal body may be any type having pores capable of being filled with the electrode material mixture. The porous metal body may be, for example, a foamed metal.

The foamed metal has a network structure having a large surface area. When the foamed metal is used as the current collector, the pores of the foamed metal can be filled with the electrode material mixture such that the amount of the electrode active material can be relatively large per unit area of the electrode, which provides an increased volume energy density for a secondary battery. In this case, the electrode material mixture can also be easily immobilized, so that a thick film of the electrode material mixture can be formed without increasing the viscosity of the slurry used when the electrode material mixture is applied. It is also possible to reduce the amount of the binder necessary to thicken the slurry. Therefore, the electrode material mixture can be formed into a film with a large thickness and a low resistance as compared to that formed when a metal foil is used as the current collector. As a result, the electrode has an increased capacity per unit area, which contributes to increasing the capacity of secondary batteries.

The porous metal body may be made of, for example, nickel, aluminum, stainless steel, titanium, copper, silver, a nickel-chromium alloy, or any other appropriate metal. In particular, the porous metal body for forming a positive electrode current collector is preferably a foamed aluminum, and the porous metal body for forming a negative electrode current collector is preferably a foamed copper or a foamed nickel.

### Electrode Material Mixture

The electrode material mixture includes an electrode active material and porous aggregates of a conductive aid. The electrode material mixture may further contain an additional component.

Examples of the additional component include a solid electrolyte, a conductive aid other than the porous aggregates of the conductive aid, and a binder.

The positive electrode active material in the positive electrode material mixture may be any appropriate material capable of storing and releasing lithium ions. Examples of the positive electrode active material include, but are not limited to, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode active material in the negative electrode material mixture may be any appropriate material capable of storing and releasing lithium ions. Examples of the negative electrode active material include, but are not limited to, metallic lithium, lithium alloys, metal oxides, metal sulfides, metal nitrides, Si, SiO, and carbon materials.

Examples of the carbon materials include artificial graphite, natural graphite, hard carbon, and soft carbon.

Examples of the material constituting the porous aggregates of the conductive aid include acetylene black, furnace black, and carbon black.

The porous aggregates of the conductive aid can be obtained through controlling the dispersibility of the conductive aid in the process of preparing a slurry containing the electrode material mixture, which will be described later.

The carbon black may be, for example, a product produced by furnace process, thermal process, or any other appropriate process.

The porous aggregates of the conductive aid preferably have a size of 5 μm or more, more preferably 10 μm or more. The ionic conductivity will increase as the size of the porous aggregates of the conductive aid increases.

The size of the porous aggregates of the conductive aid can be determined by carbon imaging of the cross-section of the electrode using SEM-EPMA.

The conductive aid other than the porous aggregates of the conductive aid may be made of a material the same as or different from that of the porous aggregates of the conductive aid.

Examples of the binder include polyvinylidene fluoride, sodium carboxymethylcellulose, styrene butadiene rubber, and sodium polyacrylate.

### Method of Producing Electrode

The electrode according to the embodiment may be produced using any method common in the field of the art.

Any appropriate method may be used to fill the pores of the current collector with the electrode material mixture, which may include, for example, using a plunger-type die coater to fill the pores of the current collector with a slurry containing the electrode material mixture under pressure.

An alternative method of filling the pores of the current collector with the electrode material mixture may include generating a pressure difference between the top and bottom surfaces of the current collector; and allowing a slurry containing the electrode material mixture to infiltrate into the pores of the current collector according to the pressure difference.

The step of filling the pores of the current collector with a slurry containing the electrode material mixture may be followed by any appropriate process common in the field of the art. For example, such a process may include drying the current collector filled with the electrode material mixture; and then pressing the current collector to form an electrode. In this process, the pressing can adjust the porosity of the current collector and the density of the electrode material mixture.

### Electricity Storage Device

The electricity storage device according to an embodiment of the present invention includes the electrode according to the embodiment and an electrolytic solution.

The electricity storage device may be, for example, a secondary battery, such as a lithium-ion secondary battery, or a capacitor.

Only the positive or negative electrode may be the electrode according to the embodiment, or each of the positive and negative electrodes may be the electrode according to the embodiment.

### Lithium-Ion Secondary Battery

The lithium-ion secondary battery according to an embodiment of the present invention includes a positive electrode, a negative electrode, a separator provided between the positive and negative electrodes, and an electrolytic solution. In the lithium-ion secondary battery according to the embodiment, at least one of the positive and negative electrodes is the electrode according to the embodiment.

In the lithium-ion secondary battery according to the embodiment, the positive or negative electrode, which is not the electrode according to the embodiment, may be any appropriate electrode that functions as a positive or negative electrode for a lithium-ion secondary battery.

The lithium-ion secondary battery according to the embodiment may be any type and may include two materials with different charge/discharge potentials selected from materials available to form electrodes, one of which has a noble potential for the positive electrode and the other of which has a potential less noble for the negative electrode.

The separator may be any known separator available for lithium-ion secondary batteries.

The separator may be made of, for example, polyethylene, polypropylene, or any other appropriate material.

The electrolytic solution may be a solution of an electrolyte in a solvent.

Examples of the electrolyte include LiPF₆, LiBF₄, and LiClO₄.

Examples of the solvent include ethylene carbonate, propylene carbonate, dimethyl carbonate, and diethyl carbonate. Two or more of these solvents may be used in combination.

### EXAMPLES

Hereinafter, examples of the present invention will be described, which are not intended to limit the present invention.

### Example 1

### Preparation of Positive Electrode

### Positive Electrode Current Collector

A foamed aluminum was provided as a positive electrode current collector. The foamed aluminum had a thickness of 1.0 mm, a porosity of 95%, a pore size of 0.5 mm, a specific surface area of 5,000 m²/m³, and 46 to 50 cells per inch.

### Preparation of Positive Electrode Material Mixture Slurry

LiNi_{0.5}Co_{0.2}Mn_{0.3}O₂ was provided as a positive electrode active material.

A mixture of 94% by mass of the positive electrode active material, 4% by mass of furnace black as a conductive aid, and 2% by mass of polyvinylidene fluoride (PVDF) as a binder was prepared and then dispersed in an appropriate amount of N-methyl-2-pyrrolidone (NMP) to form a positive electrode material mixture slurry. In the positive electrode material mixture slurry as prepared, the furnace black was in a low dispersion state.

Filling with Positive Electrode Material Mixture

The positive electrode material mixture slurry was applied at a coating weight of 90 mg/cm² to the positive electrode current collector using a plunger-type die coater, and then dried under vacuum at 120° C. for 12 hours. The positive electrode current collector filled with the positive electrode material mixture was then roll-pressed with a pressing force of 15 tons to form a positive electrode. In the resulting positive electrode, the electrode material mixture had a coating weight of 90 mg/cm² and a density of 3.2 g/cm³. The resulting positive electrode was punched into a size of 3 cm×4 cm before use.

### Preparation of Negative Electrode

### Preparation of Negative Electrode Material Mixture Slurry

A mixture of 96.5% by mass of natural graphite, 1% by mass of carbon black as a conductive aid, 1.5% by mass of styrene butadiene rubber (SBR) as a binder, and 1% by mass of sodium carboxymethylcellulose (CMC) as a thickener was prepared and then dispersed in an appropriate amount of distilled water to form a negative electrode material mixture slurry.

### Formation of Negative Electrode Material Mixture Layer

An 8 μm-thick copper foil was provided as a negative electrode current collector. The negative electrode material mixture slurry was applied at a coating weight of 45 mg/cm² to the current collector using a die coater, and then dried under vacuum at 120° C. for 12 hours. The current collector with the negative electrode material mixture layer was roll-pressed at a pressing force of 10 tons to form a negative electrode. In the resulting negative electrode, the electrode material mixture layer had a coating weight of 45 mg/cm² and a density of 1.5 g/cm³. The resulting negative electrode was punched into a size of 3 cm×4 cm before use.

### Preparation of Lithium-Ion Secondary Battery

A 25 μm-thick microporous membrane, which was a laminate of three layers: polypropylene/polyethylene/polypropylene, was provided and punched into a size of 3 cm×4 cm before use as a separator.

An aluminum laminate for a secondary battery was heat-sealed to form a bag-shaped product. The separator was placed between the positive and negative electrodes. The resulting laminate was placed in the bag-shaped product to form a laminate cell.

The electrolytic solution prepared was a solution of 1.2 mol LiPF₆ in a mixed solvent of ethylene carbonate, dimethyl carbonate, and ethyl methyl carbonate in a volume ratio of 3:4:3.

The electrolytic solution was injected into the laminate cell so that a lithium-ion secondary battery was obtained.

### Comparative Example 1

A lithium-ion secondary battery was prepared as in Example 1 except that a mixture of the conductive aid, a dispersant, and NMP was previously prepared as a conductive aid dispersion and then used instead of the conductive aid in the process of preparing the positive electrode material mixture slurry. In the resulting positive electrode material mixture slurry, the furnace black was in a high dispersion state.

### Comparative Example 2

A lithium-ion secondary battery was prepared as in Example 1 except that acetylene black was used instead of furnace black and that a mixture of the conductive aid, a dispersant, and NMP was previously prepared as a conductive aid dispersion and then used instead of the conductive aid in the process of preparing the positive electrode material mixture slurry. In the resulting positive electrode material mixture slurry, the acetylene black was in a high dispersion state.

### Observation of Cross-Section of Positive Electrode

The cross-section of each of the positive electrodes of Example 1 and Comparative Examples 1 and 2 was observed using SEM-EPMA. First, ion milling was performed to expose the cross-section of the positive electrode. In this process, the cross-section was formed at an acceleration voltage of 6 kV and a stage swing angle of ±30°. The cross section of the positive electrode was then observed using SEM-EPMA. The measurement was performed under the conditions of an acceleration voltage of 5 to 15 kV and a probe current of 1 to 10 nA. The elements subjected to mapping were carbon, fluorine, and cobalt.

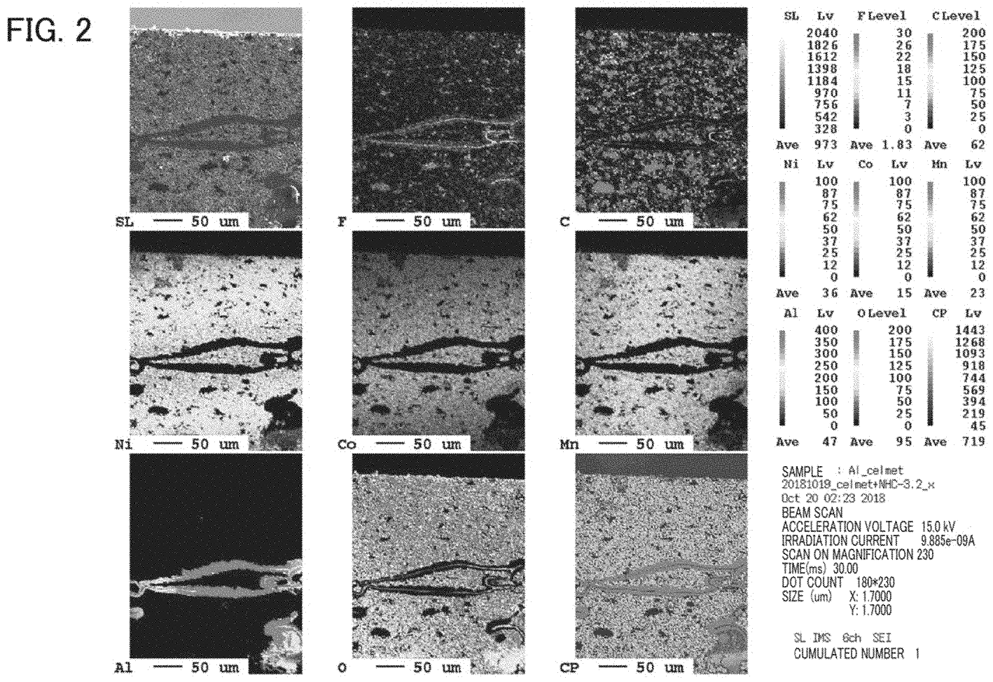

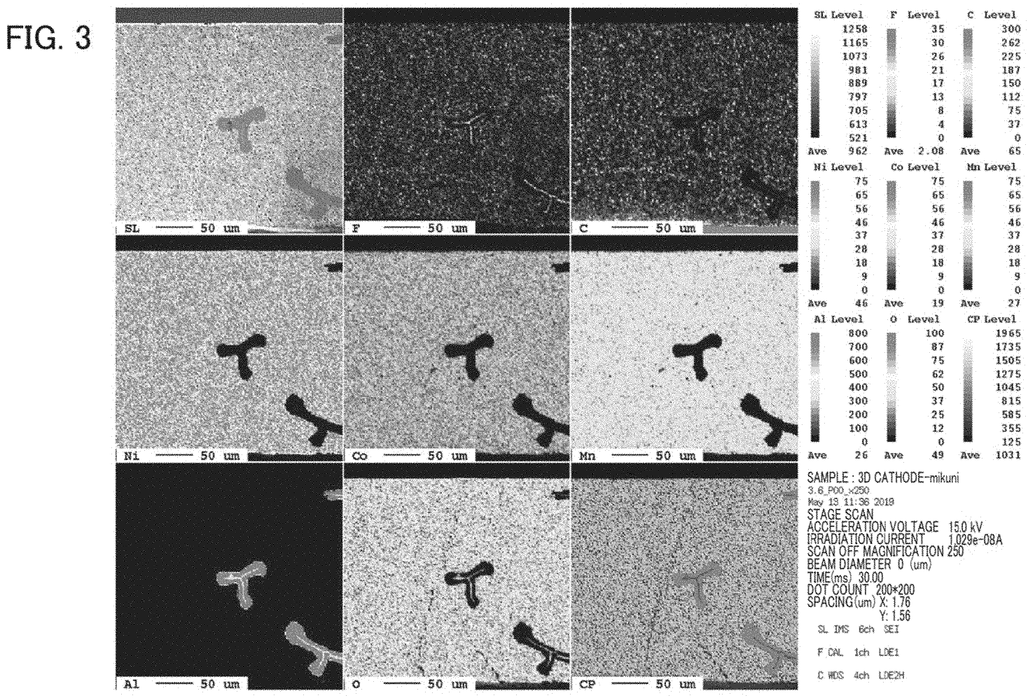

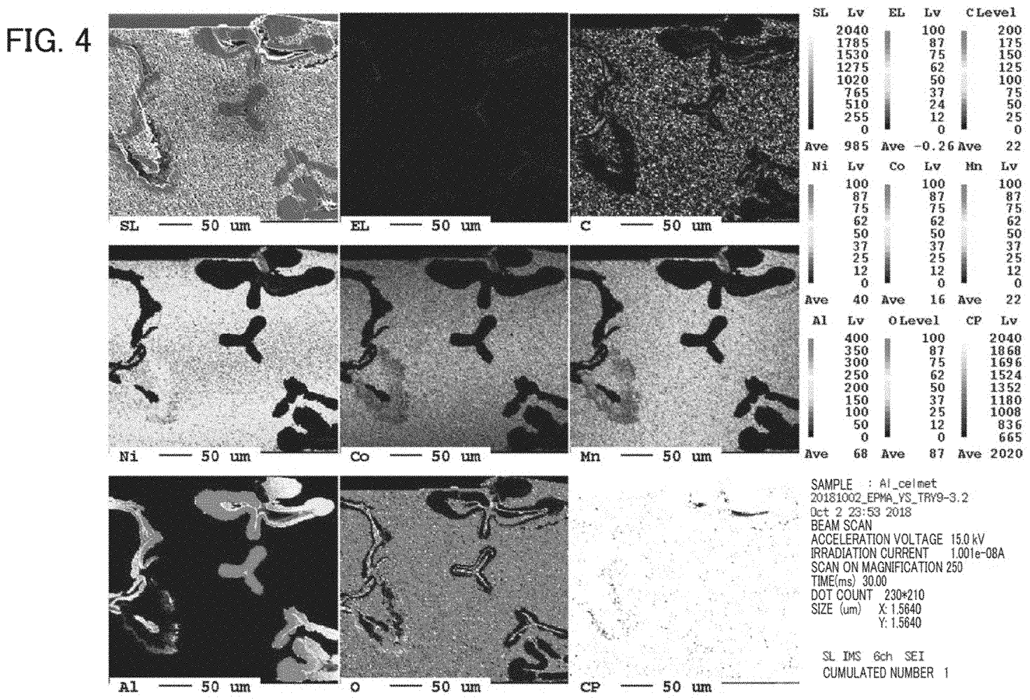

FIG. 2 shows SEM images of the cross-section of the positive electrode of Example 1 and also shows the results of the EPMA analysis. FIG. 3 shows SEM images of the cross-section of the positive electrode of Comparative Example 1 and also shows the results of the EPMA analysis. FIG. 4 shows SEM images of the cross-section of the positive electrode of Comparative Example 2 and also shows the results of the EPMA analysis.

FIGS. 2 to 4 indicate that the positive electrode of Example 1 has porous aggregates of furnace black, which have sizes of at least 5 μm, whereas the positive electrode of Comparative Example 1 has no porous aggregates of furnace black with sizes of at least 5 μm and the positive electrode of Comparative Example 2 has no porous aggregates of acetylene black with sizes of at least 5 μm.

### Evaluation of Initial Characteristics of Lithium-Ion Secondary Battery

The lithium-ion secondary battery of each of Example 1 and Comparative Examples 1 and 2 was evaluated for initial characteristics as shown below.

### Initial Discharge Capacity

The lithium-ion secondary battery was allowed to stand at a measurement temperature (25° C.) for 3 hours, then charged at a constant current of 0.33 C until 4.2 V was reached, and subsequently charged at a constant voltage of 4.2 V for 5 hours. Subsequently, the lithium-ion secondary battery was allowed to stand for 30 minutes, and then discharged at a discharge rate of 0.33 C until 2.5 V was reached, when the discharge capacity was measured. The resulting discharge capacity was determined to be the initial discharge capacity.

### Initial Cell Resistance

After the measurement of the initial discharge capacity, the lithium-ion secondary battery was adjusted to a charge level (State of Charge (SOC)) of 50%. Subsequently, the lithium-ion secondary battery was discharged at a current of 0.2 C for 10 seconds, and then its voltage was measured 10 seconds after the completion of the discharge. Next, after being allowed to stand for 10 minutes, the lithium-ion secondary battery was supplementarily charged until SOC returned to 50%, and then allowed to stand for 10 minutes. The operation shown above was performed at each of the C rates 0.5 C, 1 C, 1.5 C, 2 C, and 2.5 C. The resulting current values were plotted on the horizontal axis, and the resulting voltage values were plotted on the vertical axis. The initial cell resistance of the lithium-ion secondary battery was defined as the slope of an approximate straight line obtained from the plots.

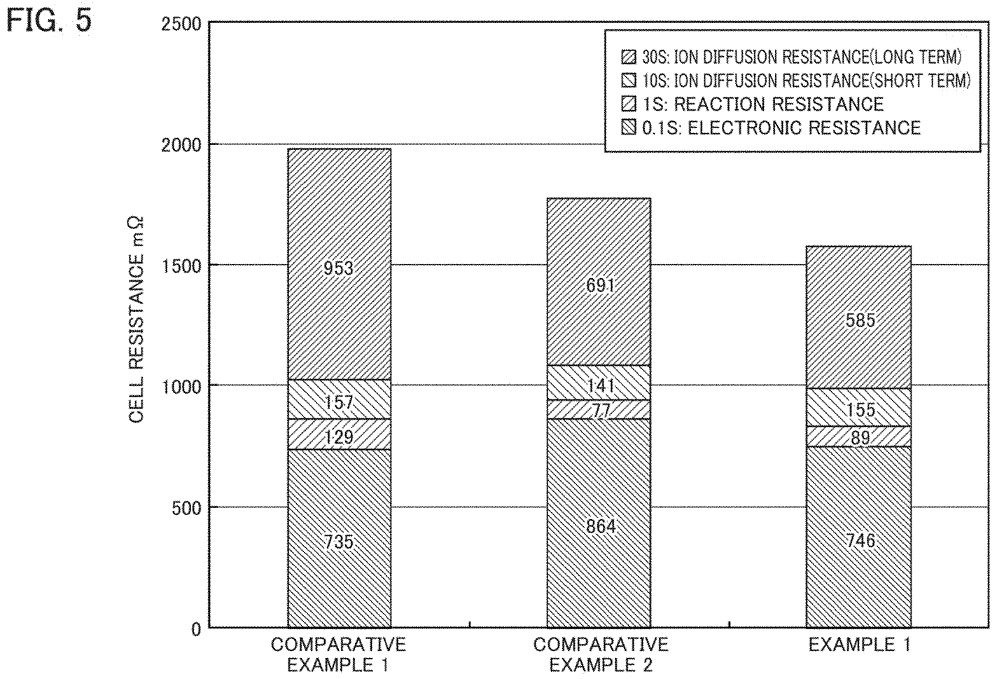

FIG. 5 shows the results of the evaluation of the initial cell resistance of the lithium-ion secondary batteries of Example 1 and Comparative Examples 1 and 2.

FIG. 5 indicates that the lithium-ion secondary battery of Example 1 has an initial cell resistance (in particular, a long-term ion diffusion resistance) lower than that of the lithium-ion secondary battery of Comparative Example 1 or 2.

### C-Rate Characteristics

After the measurement of the initial discharge capacity, the lithium-ion secondary battery was allowed to stand at a measurement temperature (25° C.) for 3 hours, then charged at a constant current of 0.33 C until 4.2 V was reached, and subsequently charged at a constant voltage of 4.2 V for 5 hours. Subsequently, the lithium-ion secondary battery was allowed to stand for 30 minutes, and then discharged at a discharge rate (C rate) of 0.5 C until 2.5 V was reached, when the initial discharge capacity was measured.

The operation shown above was performed at each of the C rates 0.33 C, 1 C, 1.5 C, 2 C, 2.5 C, 3 C, 3.5 C, and 4 C. The resulting initial discharge capacity at each C rate was converted to a capacity retention using the initial discharge capacity at 0.33 C normalized to 100%, so that its C-rate characteristics were determined.

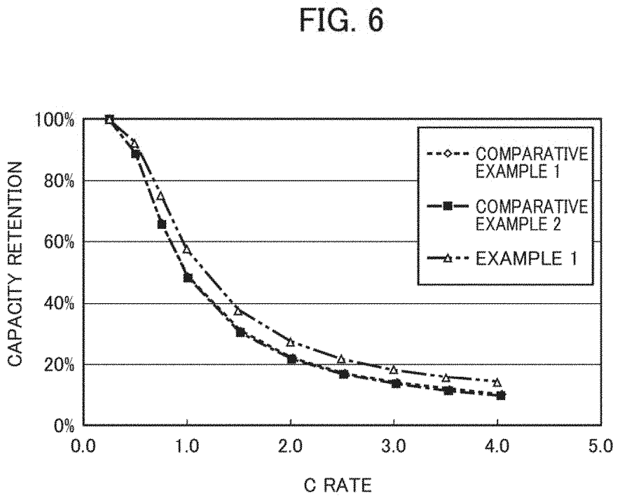

FIG. 6 shows the results of the evaluation of the C-rate characteristics of the lithium-ion secondary batteries of Example 1 and Comparative Examples 1 and 2.

FIG. 6 indicates that the lithium-ion secondary battery of Example 1 has a capacity retention higher than that of the lithium-ion secondary battery of Comparative Example 1 or 2.

Evaluation of Characteristics of Lithium-Ion Secondary Battery after Endurance Test

The lithium-ion secondary battery of each of Example 1 and Comparative Examples 1 and 2 was evaluated for characteristics after an endurance test as shown below.

Discharge Capacity after Endurance Test

In a thermostatic chamber at 45° C., the lithium-ion secondary battery was subjected to 200 cycles of charging to 4.2 V at a constant current of 0.6 C, subsequent charging at a constant voltage of 4.2 V for 5 hours or until a current of 0.1 C was reached, subsequent standing for 30 minutes, subsequent constant-current discharging to 2.5 V at a discharge rate of 0.6 C, and subsequent standing for 30 minutes. Next, in a thermostatic chamber at 25° C., the lithium-ion secondary battery, after the discharging to 2.5 V of the endurance test, was allowed to stand for 24 hours and then measured for discharge capacity in the same way as that for the initial discharge capacity. The operation shown above was repeated for each set of the 200 cycles, and the discharge capacity after the endurance test was measured until 400 cycles were completed.

Cell Resistance after Endurance Test

After the completion of the 400 cycles for the measurement of the discharge capacity after the endurance test, the lithium-ion secondary battery was adjusted to a charge level (State of Charge (SOC)) of 50% when the cell resistance after the endurance test was determined in the same way as that for the initial cell resistance.

### Capacity Retention

The capacity retention after each set of the 200 cycles was defined as the ratio of the discharge capacity after the endurance test of the 200 cycles to the initial discharge capacity.

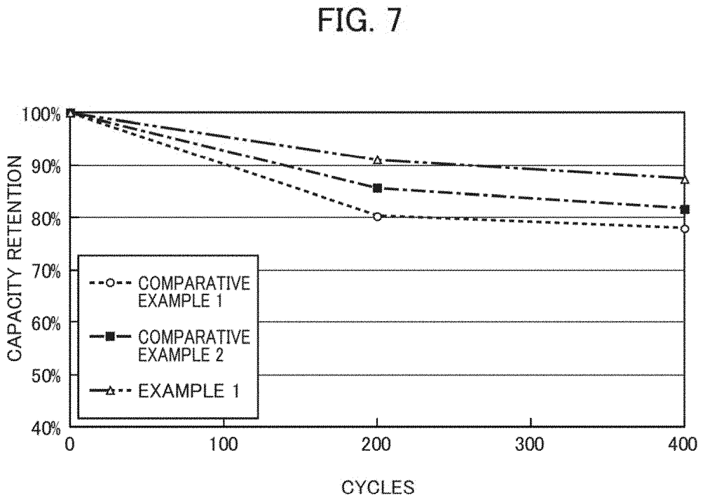

FIG. 7 shows the results of the evaluation of the capacity retention of the lithium-ion secondary batteries of Example 1 and Comparative Examples 1 and 2.

FIG. 7 indicate that the lithium-ion secondary battery of Example 1 has a capacity retention higher than that of the lithium-ion secondary battery of Comparative Example 1 or 2 after the 200 to 400 cycles.

### Rate of Change in Resistance

The rate of change in resistance was defined as the ratio of the cell resistance after the endurance test to the initial cell resistance.

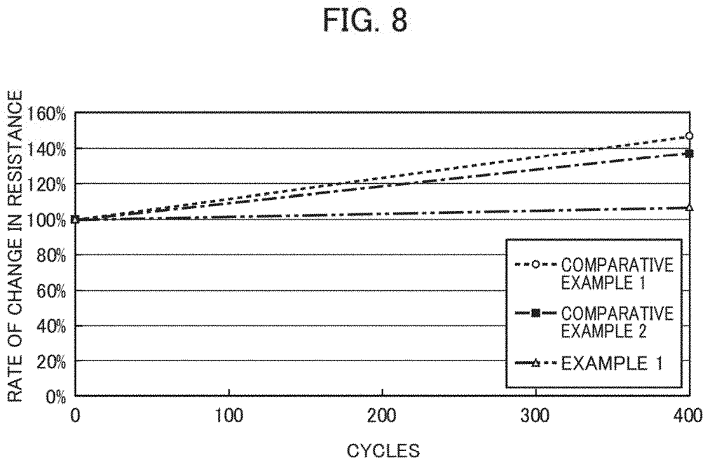

FIG. 8 shows the results of the evaluation of the rate of change in the resistance of the lithium-ion secondary batteries of Example 1 and Comparative Examples 1 and 2.

FIG. 8 indicates that the lithium-ion secondary battery of Example 1 shows a rate of change in resistance lower than that shown by the lithium-ion secondary battery of Comparative Example 1 or 2 after the 400 cycles.

The results shown above indicate that the durability of the positive electrode of Example 1 is higher than that of the positive electrode of Comparative Example 1 or 2.

### EXPLANATION OF REFERENCE NUMERALS

10: Electrode
11: Current collector
12: Electrode material mixture
13: Electrode active material
14: Porous aggregate of conductive aid

What is claimed is:

1. An electrode comprising: a current collector; and an electrode material mixture,
the current collector being a porous metal body,
the current collector having pores filled with the electrode material mixture,
the electrode material mixture comprising an electrode active material and porous aggregates of a conductive aid.

2. The electrode according to claim 1, wherein
the electrode material mixture has a three-layer structure comprising an upper layer, an intermediate layer, and a lower layer stacked in order in a thickness direction, and
the porous aggregates of the conductive aid are in the intermediate layer.

3. An electricity storage device comprising: the electrode according to claim 1; and an electrolytic solution.
